(19) United States
(12) Patent Application Publication
(10) Pub. No.: US 2004/0177529 A1
(43) Pub. Date: Sep. 16, 2004

(54) Drying device and method

(76) Inventors: Jong Wook Kim, Sungnam (KR); Hyung Ki Hong, Anyang (KR); Sun Cheol Bae, Masan (KR); Chang Woo Son, Busan (KR); Dae Woong Kim, Changwon (KR); Don Hee Lee, Anyang (KR)

Correspondence Address: BIRCH STEWART KOLASCH & BIRCH, PO BOX 747, FALLS CHURCH, VA, 22040-0747, US

(21) Appl. No.: 10/793,913

(22) Filed: Mar. 8, 2004

(30) Foreign Application Priority Data
Mar. 10, 2003 (KR) 14811/2003

(51) Int. Cl. F26B 13/10

(52) U.S. Cl. 34/562

(57) ABSTRACT

A drying device and method using a humidity sensor are disclosed. The drying device includes a controller for comparing the weight and amount of moisture of the article positioned in a drying device with predetermined data and adjusting a dry time of an article on the basis of the comparison result.

### BACKGROUND OF THE INVENTION

1. Field of the Invention

The present invention relates to a drying device and, more particularly, to a drying device using a humidity sensor and its method.

2. Description of the Background Art

In general, drying means removing moisture from an article to be dried. A method for drying an article by removing moisture with hot wind is applied to many fields such as a drying-device incorporated washing machine and a dish washer.

In many methods for removing moisture of articles, as well as the hot wind-using drying method, employs a timer to perform a drying process for a prescribed time as set by a user.

However, the hot wind-using drying method is disadvantageous in that articles are dried for a prescribed time regardless of moisture of the articles, so it is difficult to accurately adjust a dry time according to the degree of moisture of the articles.

Meanwhile, a drying method using an electrode sensor performs a drying process such that when a wet article is touched by an electrode sensor, a dried degree of the article is sensed on the basis of a difference between impedances generated from both ends of the electrode, thereby performing a drying process according to the dry degree as sensed.

However, the electrode sensor-using drying method has the following problems. That is, since a deflection of the impedance is very big according to the amount of the articles, the kind of the articles and the quantity of water, it is difficult to accurately detect a dried degree of the articles. Namely, at an early stage of the drying process, a difference between voltage values detected by the electrode sensor is so big that there is no difficulty in performing the drying process on the articles. But from a certain time point of the drying process, the difference of voltage values detected by the electrode sensor becomes small, a discrimination capability of the electrode sensor for the dry degree of the articles is degraded considerably.

Thus, the related art drying devices have problems that they can not dry articles optimally according to a dry degree.

### SUMMARY OF THE INVENTION

Therefore, one object of the present invention is to provide a drying device and method capable of optimally drying articles by comparing the weight and amount of moisture of the article positioned in a drying device with predetermined data and adjusting a dry time of an article on the basis of the comparison result.

Another object of the present invention is to provide a drying device and method capable of saving energy consumption by comparing the weight and amount of moisture of the article positioned in a drying device with predetermined data and adjusting a dry time of an article on the basis of the comparison result.

To achieve these and other advantages and in accordance with the purpose of the present invention, as embodied and broadly described herein, there is provided a drying device including a controller for comparing the weight and amount of moisture of the article positioned in a drying device with predetermined data and adjusting a dry time of an article on the basis of the comparison result.

To achieve the above objects, there is also provided a drying method including comparing the weight and amount of moisture of the article positioned in a drying device with predetermined data and adjusting a dry time of an article on the basis of the comparison result.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a block diagram showing the construction of a drying device; and

FIG. 2 is a graph showing a result of experimentation for a change of the amount of moisture and drying time according to the weight of an article.

### DETAILED DESCRIPTION OF THE PREFERRED EMBODIMENTS

Reference will now be made in detail to the preferred embodiments of the present invention, examples of which are illustrated in the accompanying drawings.

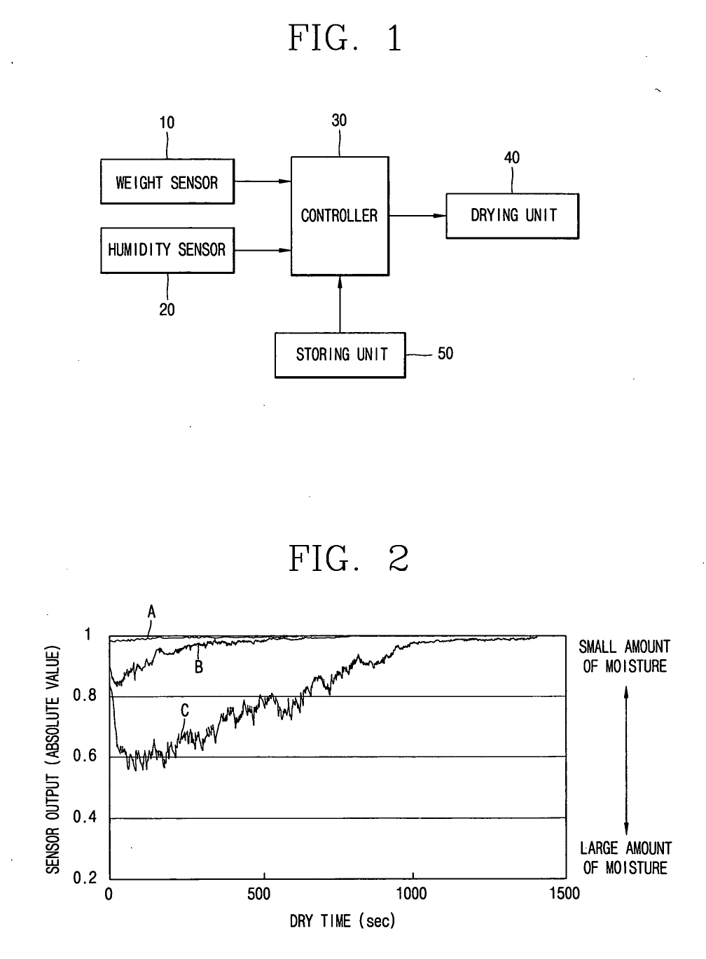

A drying device and method in accordance with a preferred embodiment of the present invention, capable of optimally drying an article and reducing an energy consumption by comparing the weight and amount of moisture of the article positioned in a drying device with predetermined data and adjusting a dry time of an article on the basis of the comparison result, will now be described with reference to FIGS. 1 and 2.

FIG. 1 is a block diagram showing the construction of a drying device.

As shown in FIG. 1, a drying device of the present invention includes a weight sensor 10 for measuring a weight of an article positioned in a drying device; a humidity sensor 20 for measuring the amount of moisture of the article; a controller 30 for comparing the measured weight and amount of moisture of the article with predetermined data and adjusting a dry time of the article on the basis of the comparison result; and a drying unit 40 for drying the article during the adjusted dry time.

The predetermined data, including a previously measured weight of the article, a previously measured amount of moisture of the article and the predetermined dry time according to the previously measured weight of the article and amount of moisture, is stored in a storing unit 50.

The principle of the operation of the drying device in accordance with the present invention will now be described in detail.

First, the weight sensor 10 measures a weight of an article positioned in the drying device, and the humidity sensor 20 measures the amount of moisture of the article. The weight sensor 10 and the humidity sensor 20 respectively output the measured weight of the article and the amount of humidity to the controller 30.

The controller 30 compares the outputted weight and the amount of moisture of the article with predetermined data stored in the storing unit 50, and controls a dry time of the article on the basis of the comparison result.

Namely, the controller 30 searches data identical to the outputted weight and amount of moisture of the article from the storing unit 50 and obtains a dry time of the article corresponding to the searched data. Herein, the predetermined data includes a previously measured weight of the article, a previously measured amount of moisture of the article and the predetermined dry time according to the previously measured weight of the article and amount of moisture.

At this time, the drying device can measure the weight of the article to be dried through the drying device, the amount of moisture of the article and a dry time of the article according to a change in the weight and amount of moisture of the article, and store the measured data in the storing unit 40, whereby the dry time of the article can be adjusted on the basis of the data stored in the storing unit 50.

A result of measurement of a dry time according to a change in the weight and the amount of moisture of the article in experimentation will now be described with reference to FIG. 2.

FIG. 2 is a graph showing a result of experimentation for a change of the amount of moisture and drying time according to the weight of an article.

As shown in FIG. 2, a change of the amount of moisture and a dry time of articles (A, B and C) positioned in the drying device according to each weight of the articles. That is, by changing the weights of the articles from A<B<C, since the changed amounts of moisture of each article differ according to the weights of each article, a dry time for each article becomes different.

Accordingly, the drying device of the present invention can obtain the effect of drying the articles optimally by predetermining a dry time according to the weight and amount of moisture of the articles on the basis of the measurement result.

Preferably, the measured data considers various parameters a maximum amount of moisture according to the weight of an article, a time taken from starting of a drying process to reach the maximum amount of moisture, and a time taken from the maximum amount of moisture to an amount of moisture prior to a drying process through the drying process, as well as the dry time according to the weight and amount of moisture of the article.

Thereafter, the drying unit 40 dries the articles during the dry time, which has been adjusted by the controller 30. The drying unit 40 preferably dries the articles through heating of a resistor or microwave.

In addition, while the drying process is performed, the drying device of the present invention can periodically measure the weight of the articles and the amount of moisture through the weight sensor 10 and the humidity sensor 20 and adjust the dry time periodically on the basis of the measured weight and amount of moisture of the articles.

As so far described, the drying device of the present invention has the following advantages.

That is, the dry time of articles is adjusted on the basis of the weight and amount of moisture of the articles positioned in the drying device, whereby an over-drying or under-drying of articles can be prevented and thus the articles can be optically dried, and in addition, an energy consumption can be reduced.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A drying device including a controller for comparing the weight and amount of moisture of the article positioned in a drying device with predetermined data and adjusting a dry time of an article on the basis of the comparison result.

2. The device of claim 1, wherein the predetermined data includes:
a previously measured weight of the article;
a previously measured amount of moisture of the article; and
a dry time that has been previously determined according to the previously measured weight and amount of moisture of the article.

3. A drying device comprising:
a weight sensor for measuring a weight of an article positioned in a drying device;
a humidity sensor for measuring the amount of moisture of the article;
a controller for comparing the measured weight and the amount of moisture of the article with predetermined data and adjusting a dry time of the article on the basis of the comparison result; and
a drying unit for drying the article during the adjusted dry time.

4. The device of claim 3, wherein the predetermined data is stored in a storing unit.

5. The device of claim 4, wherein the predetermined data includes:
a previously measured weight of the article;
a previously measured amount of moisture of the article; and
a dry time that has been previously determined according to the previously measured weight and amount of moisture of the article.

6. The device of claim 3, wherein the drying unit dries the article through heating of a resistor or microwave.

7. A drying method comprising
comparing the weight and amount of moisture of the article positioned in a drying device with predetermined data and adjusting a dry time of an article on the basis of the comparison result.

8. The device of claim 7, wherein the predetermined data includes:
a previously measured weight of the article;
a previously measured amount of moisture of the article; and
a dry time that has been previously determined according to the previously measured weight and amount of moisture of the article.

9. A drying method comprising:
measuring a weight and an amount of moisture of an article positioned in a drying device;
comparing the measured weight and the amount of moisture of the article with predetermined data and adjusting a dry time of the article on the basis of the comparison result; and
drying the article during the adjusted dry time.

10. The method of claim 9, wherein, in the measuring step, the weight of the article is measured through a weight sensor.

11. The method of claim 9, wherein, in the measuring step, the amount of moisture of the article is measured through a humidity sensor.

12. The method of claim 9, wherein the predetermined data includes:
a previously measured weight of the article;
a previously measured amount of moisture of the article; and
a dry time that has been previously determined according to the previously measured weight and amount of moisture of the article.

13. The method of claim 9, wherein, in the drying step, the article is dried through heating of a resistor or microwave.
